(19) United States
(12) Patent Application Publication
(10) Pub. No.: US 2012/0062584 A1
(43) Pub. Date: Mar. 15, 2012

(54) IMAGE DISPLAY APPARATUS AND METHOD

(76) Inventors: Norimasa Furukawa, Tokyo (JP); Ichiro Murakami, Tokyo (JP)

(21) Appl. No.: 13/321,012

(22) PCT Filed: May 20, 2010
(86) PCT No.: PCT/JP2010/058539

§ 371 Date: Nov. 17, 2011

(30) Foreign Application Priority Data
May 29, 2009 (JP) 2009-130913

(51) Int. Cl. G09G 5/02

(52) U.S. Cl. 345/589

(57) ABSTRACT

An image display apparatus and an image display method capable of suppressing the color breakup occurring during eye tracking of a picture with motion in a field-sequential display are provided. A display section (a display panel 2 and a backlight 3) time-divisionally displays, in a manner of the field-sequential display, field images of plural colors in a display sequence controlled by a display sequence control section 12. The display sequence of the field images of plural colors is controlled to allow a composite luminance distribution perceived by a viewer on his retina to have a predetermined profile, the composite luminance distribution being created based on a group of field images which configures a frame or two frames in successive time sequence in a picture with motion displayed on the display section, the predetermined profile having highest luminance in a mid-range thereof and having luminance getting lower toward a periphery thereof to spread with bilateral-symmetry.

### TECHNICAL FIELD

The present invention relates to an image display apparatus and an image display method in which a color image is displayed in a manner of field-sequential display.

### BACKGROUND ART

Color image display systems are broadly classified into two systems based on additive color mixture methods. A first system is an additive color mixture based on a spatial color mixture principle. More specifically, sub-pixels of three primary colors R (red), G (green) and B (blue) of light are arranged in a plane at high density, and respective colors are not distinguishable with use of spatial resolution of human eyes, and the colors are mixed in a single screen to obtain a color image. This first system is employed in most of currently commercially available systems such as CRT (cathode ray tube) systems, PDP (plasma display panel) systems, and liquid crystal systems. When the first system is used to configure a display of a type which displays an image by modulating light from a light source (a backlight), for example, a display using non-self-luminous elements typified by liquid crystal elements as modulation elements, the following issues arise. That is, three systems corresponding to respective RGB colors of drive circuits driving sub-pixels are necessary in a single screen. Moreover, color filters of RGB are necessary. Moreover, the presence of the color filters reduces a light utilization rate to ⅓, because the color filters absorb light from a light source.

A second system is an additive color mixture based on temporal color mixture. More specifically, the three primary colors RGB of light are divided along a time axis and planar images of the respective primary colors are sequentially displayed with time (time-sequentially). When switching of screens from one to another is performed at too high a speed to perceive respective screens with use of temporal resolution of human eyes, respective colors are not allowed to be distinguished by temporal color mixture based on an integration effect of eyes in a time direction, thereby displaying a color image through temporal color mixture. This system is typically called field-sequential display.

When the second system is used to configure a display using non-self-luminous elements typified by, for example, liquid crystal elements as modulation elements, there are following advantages. Namely, as a state where each screen at each moment displays a monochromatic color is obtained, a spatial color filter for distinguishing colors in each pixel in a plane is not necessary. Moreover, light from a light source is changed into a monochromatic color for a black-and-white display screen, and switching of screens from one to another is performed at too high a speed to perceive respective screens. Then, it is only necessary to perform switching display images from one to another in response to an R signal, a G signal and a B signal in synchronization with changing backlight, based on the integration effect of eyes in a time direction, into, for example, each of monochromatic colors RGB; therefore, only one drive circuit system is necessary.

Moreover, since color selection is performed by time switching of colors, and as described above, no color filter is necessary, the second system has an advantage of reducing a transmission loss of the amount of light. Therefore, at present, the second system is mainly utilized as a modulation system of a high-luminance high-heat light source, such as a projector (a projection display system), in which a reduction in the amount of light tends to cause critical thermal loss. Further, as the second system has an advantage of high light use efficiency, various studies of the second system have been conducted.

However, the second system has a serious drawback in visual perception. More specifically, the basic display principle of the second system is that switching of screens from one to another is performed at too high a speed to perceive respective screens with use of the temporal resolution of human eyes. However, RGB images which are time-sequentially displayed are not properly mixed with one another, because of complicated factors such as limitation in optic nerves of eyeballs and an image recognition sense of a human brain. Accordingly, when an image with low color purity such as a white image is displayed or when eyes of a viewer track a moving object displayed on a screen, an image of each primary color is seen as an afterimage or the like to cause a display phenomenon called color breakup (color breaking) giving a feeling of discomfort to the viewer.

Various approaches have been proposed to overcome the drawback of the second system. For example, there is a drive system for reducing color breakup by performing a color sequential drive without a color filter and inserting a white display frame for preventing color breakup to achieve continuous spectral energy stimulus on a retina.

As such a technique in related art, for example, a technique of reducing color breakup by providing a field for mixing a white light component period in each field of a RGB field-sequential display is known (for example, refer to PTL 1). As another technique in related art, a technique of preventing color breakup by extracting white components and additionally inserting W fields into a sequence of fields RGBRGB . . . to provide a four-field-sequential display with a sequence of four fields RGBWRGBW . . . is known (for example, refer to PTL 2). Moreover, a technique of preventing color breakup by extracting image information and changing the coordinates of color origin points of the primary colors (basic colors) to be processed is known (for example, refer to PTL 3). Various techniques for improving field-sequential display have been proposed (refer to PTLs 4 to 7).

### CITATION LIST

### Patent Literature

[PTL 1] Japanese Unexamined Patent Application Publication No. 2008-020758
[PTL 2] Japanese Patent No. 3912999
[PTL 3] Japanese Patent No. 3878030
[PTL 4] Japanese Unexamined Patent Application Publication No. 2008-310286
[PTL 5] Japanese Unexamined Patent Application Publication No. 2007-264211
[PTL 6] Japanese Unexamined Patent Application Publication (Published Japanese Translation of PCT Application) No. 2008-510347
[PTL 7] Japanese Patent No. 3977675

### DISCLOSURE OF THE INVENTION

The technique disclosed in PTL 1 has a drawback in that, when a display image region with high color purity exists on a display screen, white light is mixed thereinto to reduce the color purity of the display image region, thereby not reproducing a correct color. Moreover, when an attempt is made to reduce color breakup while maintaining color purity, it is presumed that, for example, it is necessary for the frequency of sub-fields to be increased to 180 Hz or higher. In other words, to reduce color breakup to a visually unperceivable level or less, it is necessary to set a fairly high field frequency to increase the number of fields. At least in the response capability of a currently available liquid crystal panel, even if a drive frequency of 360 Hz is achieved with use of high-speed liquid crystal, white field insertion results in a four-field cycle of RGBW; therefore, a frequency between same-color fields is ¼, i.e., 90 Hz. With this frequency, color breakup is not allowed to be sufficiently reduced. A frequency of 360 Hz is achieved with use of a DMD or the like in a projection type projector other than a liquid crystal system; however, with this frequency, color breakup is not allowed to be reduced to the visually perceivable level or less.

In the related art disclosed in PTL 2, since the frequency between W and W is ¼ of a field frequency, the effect of preventing color breakup is small. On the other hand, when simultaneous lighting in each field is performed as in the case of the related art disclosed in PTL 1, color purity decreases.

In the technique disclosed in PTL 3, when a case where an image region with high saturation such as a primary color exists partially on the screen is considered as an example, it is necessary for a basic color to have its original colors in order to maintain the color purity of the image region. Therefore, other regions, i.e., black-and-white regions on the screen cause color breakup, because RGB are divided along a time axis. Accordingly, maintenance of color purity in parts and prevention of color breakup on the screen are not compatible with each other.

In the technique disclosed in PTL 4, when a region with high color purity of a saturated color does not exist in an image, the image is defined as a mild image, and in such a case, a white component is lit over the whole surface through color mixing by a backlight, thereby preventing color breakup. In this technique, colored image regions with high saturation other than the mild image are studded in one image plane. Thus, the existence of the regions with high saturation in a screen causes a reduction in chroma by lighting over the whole surface through color mixing; therefore, maintenance of color purity in parts and prevention of color breakup in the screen are not compatible with each other.

In order to prevent color breakup without use of a color filter, various techniques of reducing color breakup by performing various types of processing along a time axis have been also studied, since in-space modulation is considered impossible. However, since frame-sequential images which are completely separated into RGB have no inter-field correlation in color therebetween, color breakup occurs under the present situation. Thus, only effective methods as measures to prevent color breakup are a method of mixing white by sacrificing color purity and a method of compensating for little inter-frame correlation by increasing the field frequency, for example, by increasing the field frequency to insert white frames.

Moreover, PTL 5 describes luminance on a retina with use of various space-time diagrams and various retina diagrams. It is also described that color breakup is reduced with a sequence of RGBKKK with K as a black screen. A figure illustrating a luminance distribution on a retina in PTL 5 is depicted to be a center-symmetric trapezoidal shape even though a target image is decomposed into integration of RGB images having different luminance. However, since a composition target is a primary-color image rather than a black-and-white image having a uniform luminance component, lateral luminance along an eye-tracking reference on a retina is actually not shaped to be center-symmetric like the figure. In other words, the figure lacks preciseness, and actually, such a luminance distribution is expected to be insufficiently balanced in luminance as illustrated in FIG. 30 in the present application which will be described later. As a result, in the technique described in PTL 5, a color difference and a luminance difference occurring between the front and the back in an image movement direction are visually perceived as shifts; therefore, effectiveness is small, compared to a display method, which will be described later, as proposed in the present application.

The technique disclosed in PTL 6 is a proposal that measures are taken in such a manner that for the purpose of correcting a shift in an image on a retina occurring during eye tracking of a picture with motion, a movement portion of a picture signal is detected, and a display picture is displayed while being shifted in a movement direction in advance. The method is effective while eyes of a viewer are tracking the portion; however, whether his eyes track the portion or not is determined subjectively by the viewer. Therefore, the technique has a critical drawback in that when eyes are fixed on a single point, or when objects moving different directions are displayed simultaneously, further degraded color breakup is perceived due to a process of displacing a picture which is not originally displaced, and consequently the technique is not allowed to be used practically.

PTL 7 describes a proposal that RGBYeMgCy are allocated at six-fold speed. This proposal lacks the concept of a luminance center with respect to eye tracking, and it has been confirmed by an experiment by the inventor of the present application that measures to prevent color breakup in this proposal are not effective, compared to the display method, which will be described later, as proposed in the present application.

Thus, while various proposals have been made to suppress color breakup, any of the proposals does not sufficiently consider imaging balance of luminance on a retina. Therefore, in the case where the eyes track a picture with motion, an asymmetric luminance distribution on a retina is formed, and consequently, color breakup is not suppressed sufficiently.

The present invention is made to solve the above-described issues, and it is an object of the invention to provide an image display apparatus and an image display method capable of suppressing color breakup occurring during eye tracking of a picture with motion in a field-sequential display.

An image display apparatus according to an embodiment of the invention includes: a signal processing section decomposing, in each frame, an input image into a plurality of color-component images necessary for color display to generate field images of plural colors for a field-sequential display; a display sequence control section variably controlling, in each frame, a display sequence of the field images of plural colors within a frame period; and a display section time-divisionally displaying, in a manner of the field-sequential display, the field images of plural colors in the display sequence controlled by the display sequence control section. Then, the display sequence control section controls the display sequence of the field images of plural colors to allow a composite luminance distribution perceived by a viewer on his retina to have a predetermined profile, the composite luminance distribution being created based on a group of field images which configures a frame or two frames in successive time sequence in a picture with motion displayed on the display section, the predetermined profile having highest luminance in a mid-range thereof and having luminance getting lower toward a periphery thereof to spread with bilateral-symmetry.

In the image display apparatus according to the embodiment of the invention, the display sequence of the field images of plural colors is controlled to allow a composite luminance distribution perceived by a viewer on his retina to have a predetermined profile, the composite luminance distribution being created based on a group of field images which configures a frame or two frames in successive time sequence in a picture with motion displayed on the display section, the predetermined profile having highest luminance in a mid-range thereof and having luminance getting lower toward a periphery thereof to spread with bilateral-symmetry.

In the image display apparatus or an image display method according to the embodiment of the invention, the display sequence of the field images of plural colors is controlled to allow a composite luminance distribution perceived by a viewer on his retina to have a predetermined profile, the composite luminance distribution being created based on a group of field images which configures a frame or two frames in successive time sequence in a picture with motion displayed on the display section, the predetermined profile having highest luminance in a mid-range thereof and having luminance getting lower toward a periphery thereof to spread with bilateral-symmetry; therefore, color breakup occurring in eye tracking of a picture with motion in the field-sequential display is allowed to be suppressed by human visual characteristics.

### BRIEF DESCRIPTION OF THE DRAWINGS

FIG. 1 is a block diagram illustrating a configuration example of an image display apparatus according to a first embodiment of the invention.

FIG. 2 is an explanatory diagram illustrating structures of sub-field images within a frame period displayed on the image display apparatus according to the first embodiment, where a vertical axis indicates a display signal level.

FIG. 3 is an explanatory diagram illustrating structures of sub-field images within a frame period displayed on the image display apparatus according to the first embodiment, where a vertical axis indicates a display luminance level.

FIG. 4 is an explanatory diagram schematically illustrating a display state of an image by the image display apparatus according to the first embodiment.

FIG. 5 is an explanatory diagram schematically illustrating a luminance distribution of respective color components on a retina within a frame period in the display state illustrated in FIG. 4.

FIG. 6 is an explanatory diagram schematically illustrating a composite luminance distribution of respective colors on a retina in the display state illustrated in FIG. 4.

FIG. 7 is an explanatory diagram schematically illustrating the movement of an eyeball in the case where an eye tracks a moving object displayed on a display.

FIG. 8 is an explanatory diagram of an eye-tracking line (an eye-tracking velocity line) in the case where an eye tracks a moving object displayed on a display.

FIG. 9 is an explanatory diagram illustrating spatial frequency characteristics of human eyes with respect to chromaticity.

FIG. 10 is an explanatory diagram illustrating spatial frequency characteristics of human eyes with respect to the movement velocity of a displayed object.

FIG. 11 illustrates human visual characteristics, where (A) is an explanatory diagram illustrating a relationship between light stimulus presentation duration and apparent brightness and (B) is an explanatory diagram illustrating sensuous intensity changes in apparent brightness of respective colors.

FIG. 12 is an explanatory diagram schematically illustrating the acceptable amount of a spatial color shift based on human visual characteristics.

FIG. 13 is an explanatory diagram illustrating structures of sub-field images within a frame period displayed on an image display apparatus according to a second embodiment, where a vertical axis indicates a display signal level.

FIG. 14 is an explanatory diagram illustrating structures of sub-field images within a frame period displayed on the image display apparatus according to the second embodiment, where a vertical axis indicates a display luminance level.

FIG. 15 is an explanatory diagram schematically illustrating a display state of an image by the image display apparatus according to the second embodiment.

FIG. 16 is an explanatory diagram schematically illustrating a luminance distribution of respective color components on a retina within a frame period in the display state illustrated in FIG. 15.

FIG. 17 is an explanatory diagram illustrating a display state within two frame periods displayed on the image display apparatus according to the second embodiment, where a vertical axis indicates a display luminance level.

FIG. 18 is an explanatory diagram illustrating a display state within two frame periods displayed on an image display apparatus according to a third embodiment, where a vertical axis indicates a display luminance level.

FIG. 19 is an explanatory diagram schematically illustrating a display state of an image by an image display apparatus according to a fourth embodiment.

FIG. 20 is an explanatory diagram schematically illustrating a composite luminance distribution on a retina within two frame periods in the display state illustrated in FIG. 19.

FIG. 21 is an explanatory diagram schematically illustrating a display state of an image by an image display apparatus according to a fifth embodiment, where (A) is an explanatory diagram illustrating a state where some red components are removed from the display state illustrated in FIG. 19, and (B) is an explanatory diagram illustrating a state where some red components are removed from the display state illustrated in FIG. 19 and spaces are closed up.

FIG. 22 is an explanatory diagram schematically illustrating a display state of an image by an image display apparatus according to a sixth embodiment.

FIG. 23 (A) is an explanatory diagram schematically illustrating a luminance distribution on a retina in a first frame in the display state illustrated in FIG. 22, (B) is an explanatory diagram schematically illustrating a luminance distribution on a retina in a second frame in the display state in FIG. 22, and (C) is an explanatory diagram schematically illustrating a composite luminance distribution on a retina within two frame periods in the display state illustrated in FIG. 22.

FIG. 24 is an explanatory diagram schematically illustrating a display state of an image in a comparative example relative to the sixth embodiment.

FIG. 25 (A) is an explanatory diagram schematically illustrating a luminance distribution on a retina in a first frame in the display state illustrated in FIG. 24, (B) is an explanatory diagram schematically illustrating a luminance distribution on a retina in a second frame in the display state illustrated in FIG. 24, and (C) is an explanatory diagram schematically illustrating a composite luminance distribution on a retina within two frame periods in the display state illustrated in FIG. 24.

FIG. 26 is a configuration diagram illustrating a schematic configuration of an image display apparatus according to a seventh embodiment.

FIG. 27 is an explanatory diagram schematically illustrating a field-sequential image display in related art.

FIG. 28 is an explanatory diagram schematically illustrating a display state in the case where a moving object is displayed by decomposing an image in a frame into field images of three colors in a sequence of R, G and B by a field-sequential display in related art, together with a luminance distribution on a retina.

FIG. 29 is an explanatory diagram of color breakup occurring in the field-sequential display in related art.

FIG. 30 is an explanatory diagram more precisely illustrating a luminance distribution on a retina in the display state illustrated in FIG. 28.

### BEST MODE(S) FOR CARRYING OUT THE INVENTION

Embodiments of the invention will be described in detail below referring to the accompanying drawings.

### First Embodiment

### [Whole Configuration of Image Display Apparatus]

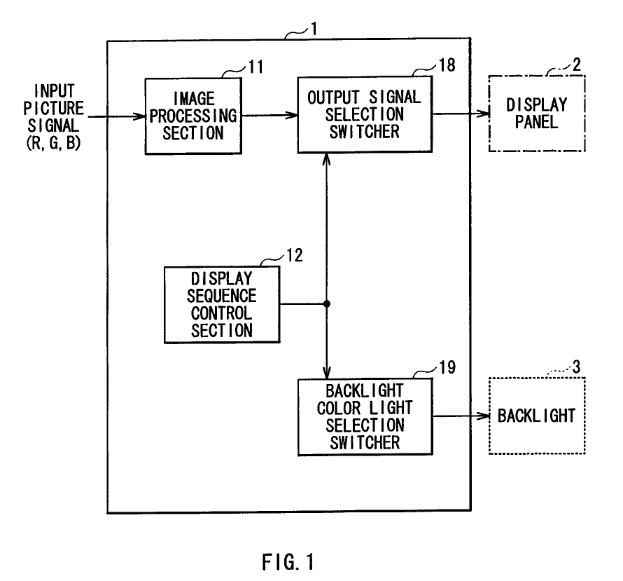

FIG. 1 illustrates a configuration example of an image display apparatus according to a first embodiment of the invention. The image display apparatus includes a display control section 1 where a picture signal including RGB color image signals representing an input image is to be entered. Moreover, the image display apparatus includes a display panel 2 which is controlled by the display control section 1 to display a color image in a manner of a field-sequential display, and a backlight 3.

The display panel 2 displays an image in synchronization with emission of each color light of the backlight 3. The display panel 2 time-divisionally displays a plurality of field images in a manner of the field-sequential display in a display sequence controlled by the display control section 1. The display panel 2 is configured of, for example, a transmissive liquid crystal panel displaying an image through controlling, by liquid crystal molecules, passage of light emitted from the backlight 3. A plurality of display pixels are regularly two-dimensionally arranged on a display surface of the display panel 2.

The backlight 3 is a light source section allowed to time-divisionally emit plural kinds of color light necessary for color image display from one to another. The backlight 3 is driven under control by the display control section 1 to emit light in response to a picture signal to be entered. The backlight 3 is disposed, for example, on a back side of the display panel 2 to apply light to the display panel 2. The backlight 3 is allowed to be configured with use of, for example, LEDs (Light Emitting Diodes) as light emitting elements (light sources). The backlight 3 is configured, for example, by two-dimensionally arranging a plurality of LEDs in a plane to allow plural kinds of color light to be independently surface-emitted. However, the light-emitting elements are not limited to LEDs. The backlight 3 is configured of, for example, a combination of at least red LEDs emitting red light, green LEDs emitting green light, and blue LEDs emitting blue light. Then, under control by the display control section 1, respective color LEDs are allowed to independently emit light (be turned on), thereby emitting primary-color light, and to emit achromatic-color (black-and-white) light or complementary-color light by additively mixing respective kinds of color light. Herein, an achromatic color refers to black, gray and white each having only brightness between hue, brightness and chroma as three attributes of color. The backlight 3 is allowed to emit yellow as one of complementary colors, for example, by turning off blue LEDs, and turning on red LEDs and green LEDs. Moreover, the backlight 3 is allowed to simultaneously emit light with appropriate color balance by appropriately adjusting the light emission amounts of respective color LEDs, thereby emitting a complementary color or an arbitrary color other than white.

[Circuit Configuration of Display Control Section]

The display control section 1 is allowed to generate field images of plural colors for field-sequential display from a color image included in the picture signal as an input image, and to variably control a display sequence of the field images of plural colors in each frame. The display control section 1 includes an image processing section 11, a display sequence control section 12, an output signal selection switcher 18 and a backlight color light selection switcher 19.

In the embodiment, the display panel 2 and the backlight 3 correspond to specific examples of “a display section” in the invention. The image processing section 11 and the output signal selection switcher 18 correspond to specific examples of “a signal processing section” in the invention. The display sequence control section 12 corresponds to a specific example of “a display sequence control section” in the invention.

The image processing section 11 decomposes the input image in each frame into a plurality of color-component images necessary for color display to generate field images of plural colors for a field-sequential display. More specifically, the input image is decomposed into primary-color images of a red component, a green component and a blue component as a plurality of color-component images to generate field images of three colors, i.e., a red field image, a green field image and a blue field image as field images of plural colors.

The output signal selection switcher 18 selectively outputs the field images of plural colors generated in the image processing section 11 to the display panel 2 under control by the display sequence control section 12.

The backlight color light selection switcher 19 controls light-emission colors and light emission timing of the backlight 3 under control by the display sequence control section 12. The backlight color light selection switcher 19 controls light emission of the backlight 3 to allow the backlight 3 to appropriately emit color light necessary for a field image to be displayed in synchronization with timing of the field image to be displayed.

The display sequence control section 12 variably controls a display sequence of the field images of plural colors generated in the image processing section 11 in each frame within a frame period through the output signal selection switcher 18 and the backlight color light selection switcher 19. The display sequence control section 12 controls an output sequence of the field images of plural colors to be displayed on the display panel 2 through the output signal selection switcher 18. The display sequence control section 12 also controls a light-emission sequence of light-emission colors from the backlight 3 through the backlight color light selection switcher 19.

When an picture with motion is displayed on the display panel 2, the display sequence control section 12 controls the display sequence of the field images of plural colors to allow a composite luminance distribution which is perceived by a viewer on his retina and is created based on a group of field images configuring one frame in a picture with motion displayed on the display panel 2 to have a predetermined profile. The predetermined profile is a profile in consideration of human visual characteristics which will be described later, and has highest luminance in a mid-range thereof and has luminance getting lower toward a periphery thereof to spread with bilateral-symmetry.

### Display Method by Technique in Related Art

Before describing an operation (display method) of the image display apparatus, first, a display technique in a manner of a field-sequential display in related art and drawbacks thereof will be described for comparison therewith. It is to be noted that the following description is given assuming that a typical model in color sense characteristics and viewing environment is used except for a particular case. It is assumed that, in the typical model, a viewer is a person with normal color vision, and an image is displayed in a photopic vision environment.

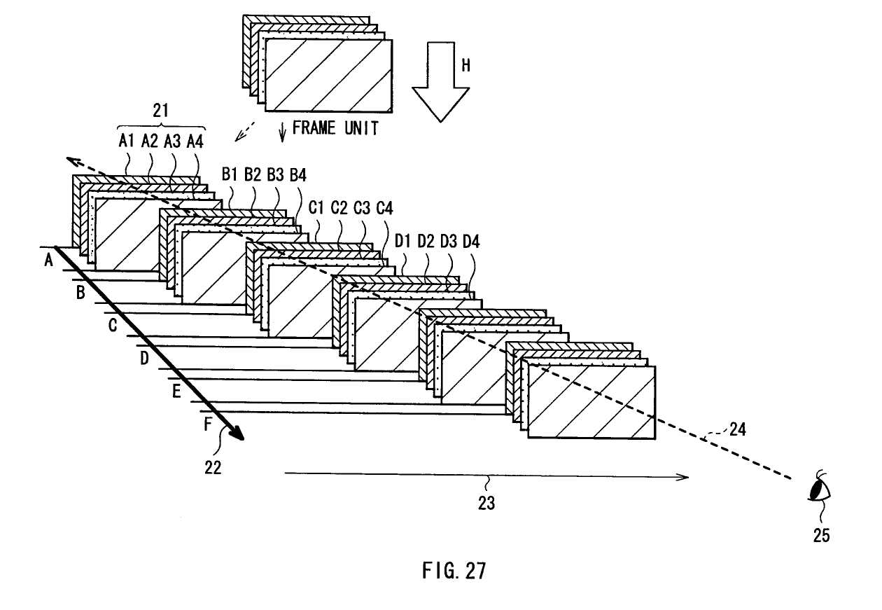

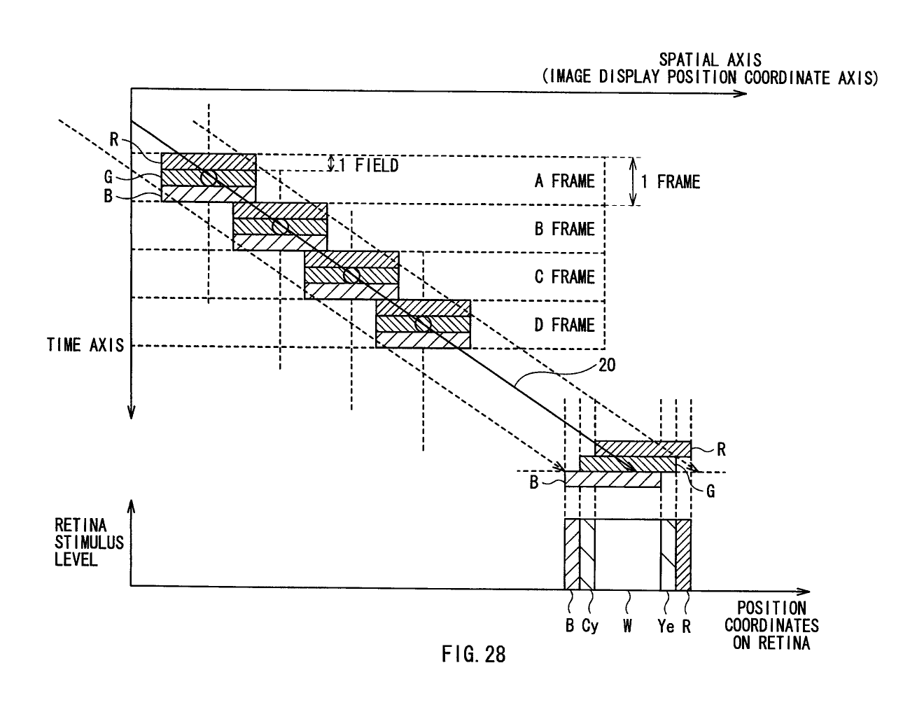

FIG. 27 illustrates a concept of a field-sequential image display. In this display example, an image in a frame is decomposed into a plurality of color-component images (field images). FIG. 27 is a time-space diagram illustrating a state where images in a frame spatially move to the right with time. In FIG. 27, frame images are displayed in a frame sequence of A, B, C, D, . . . . Each frame image is divided into subfields of four colors. For example, a frame A is configured as a frame unit of divided sub-fields A1, A2, A3 and A4 of colors. An arrow 22 indicates time passage, and an arrow 23 indicates a spatial axis (image display position coordinate axis). An arrow 24 indicates the center of viewing by a viewer 25 (eye-tracking reference). Incidentally, such spatial representation using stereoscopic representation is not general, and representation is typically made using a plan view like FIG. 28 as viewed from above in an arrow H direction. Hereinafter, a representation form of FIG. 28 is used for description.

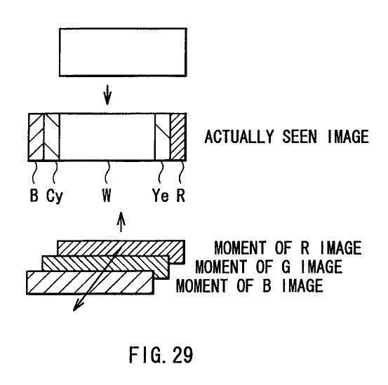

FIG. 28 illustrates a state where images in frames decomposed into RGB three fields move to the right in a manner of the field-sequential display (on an upper side of the drawing). Respective field images are displayed in a sequence of R, G, and B within a frame period. An eye-tracking reference axis (eye-tracking line) 20 is assumed to be in a central position of a G field image displayed at a center within a frame period. FIG. 28 further illustrates images superimposed on a retina (a luminance distribution on a retina) during eye tracking (on a lower side of the drawing). In a case like FIG. 28, an obvious color shift called color breakup occurs in the front and the rear of the images in a moving direction. In other words, when an image being originally white is moved to the right in a field structure as illustrated in FIG. 28, an image actually seen is separated in color at lateral ends as illustrated in FIG. 29.

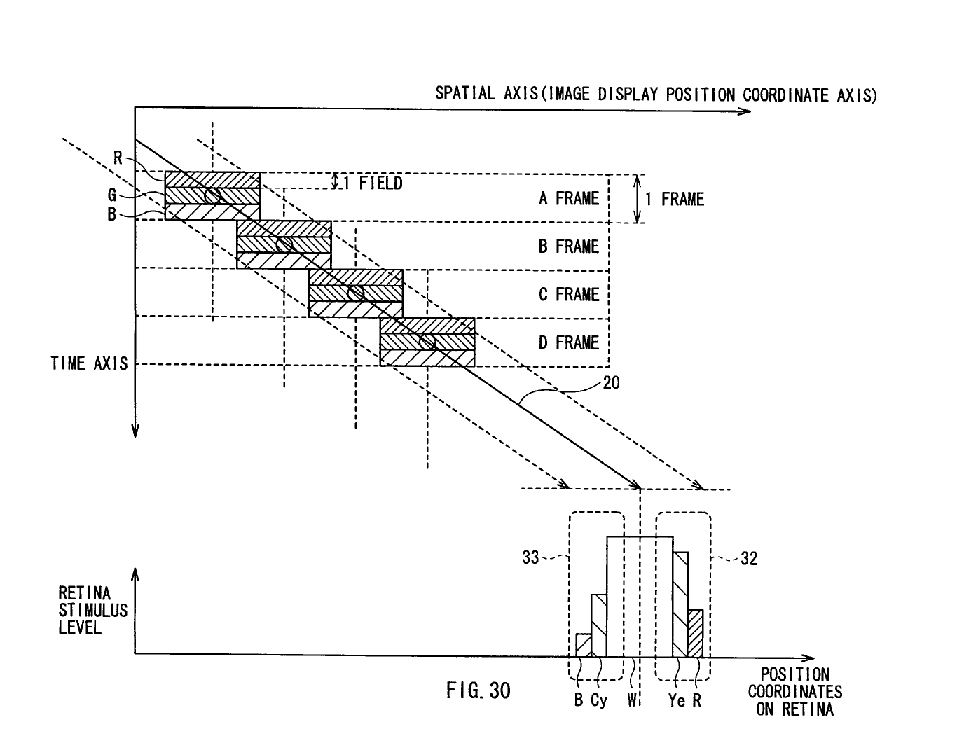

Incidentally, the luminance distribution on a retina illustrated on the lower side of FIG. 28 is incorrect. Thus, FIG. 30 correctly illustrates the luminance distribution on a retina. While “retina stimulus level” is illustrated as a unit of a vertical axis, the retina stimulus level may be substantially similar to luminance after visibility processing.

For example, a luminance component Y is represented as follow in SDTV (where * indicates a multiplication symbol).

Y=0.299*R+0.587*G+0.114*B

Strictly speaking, various conversion equations exist in accordance with various standards; however, an easy one is used in the embodiment for ease of understanding. In this luminance conversion equation, each of RGB primary-color signals considers a typical luminosity factor. When each of RGB primary-color signals considers the typical luminosity factor, the RGB primary-color signals are converted to allow a luminance ratio to be approximately R:G:B=0.3:0.6:0.1.

Therefore, although the luminance distribution is generally flat on a retina in FIG. 28, when a luminosity factor is considered, a luminance level distribution is, to be precise, different between lateral two ends as illustrated in FIG. 30. More specifically, as illustrated in FIG. 30, a luminance distribution is different between a right region 32 where shifts in a yellow component Ye and a red component R are perceived, and a left region 33 where shifts in a blue component B and a cyan component Cy are perceived. In short, a luminance energy distribution becomes irregular, bilaterally asymmetric and uneven on a retina composite image.

In FIGS. 28 and 30, the eye-tracking reference axis (eye-tracking line) 20 is meaningfully drawn through image regions of green components G with highest luminance in consideration of luminosity factor. When the luminosity factor is considered, luminances of other components including the red components R and the blue components B are relatively low. Since an eye unconsciously tracks a brightest image, the eye-tracking reference axis 20 is set in regions of the green components G with relatively high luminance.

### Display Method in Embodiment

The display method according to the embodiment will be described on the basis of the above display technique in related art. In consideration of the human visual characteristics, it is considered that when a picture with motion is displayed, a luminance distribution has a predetermined shape which has high luminance energy in a mid-timing zone and is symmetric in terms of time within a frame period, thereby allowing color breakup to be suppressed. The embodiment achieves such a display technique.

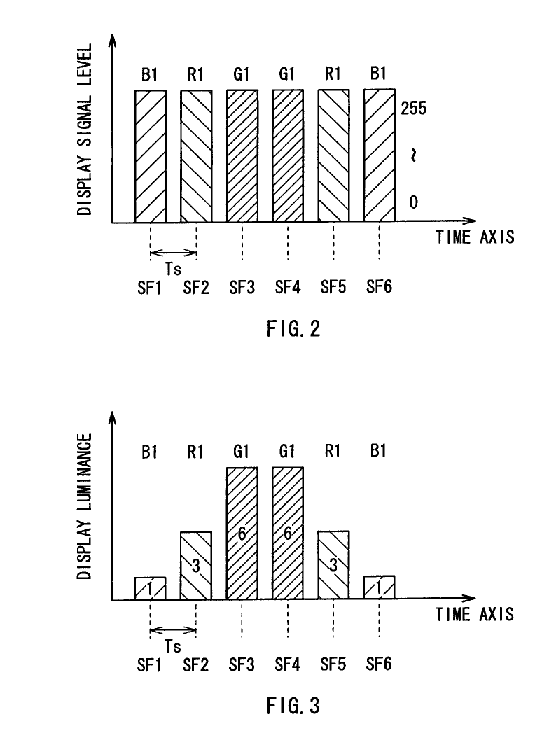

FIG. 2 illustrates structures of sub-field images to be displayed within a frame period in the embodiment, where a vertical axis indicates a display signal level. The signal level of a black level is 0, and the signal level of a white level is 255. Herein, a white image (a white-level image) is displayed, and the signal level of each of the sub-field images of colors is 255. Ts indicates a sub-field display interval. FIG. 3 is an explanatory diagram illustrating the structures of the sub-field images in FIG. 2, where a vertical axis indicates a display luminance level. The luminance ratio of RGB primary-color signals is typically represented as R:G:B of 3:6:1 by the above-described conversion equation of the luminance component Y.

As illustrated in FIGS. 2 and 3, in the embodiment, a frame is divided into six sub-fields SF1 to SF6 to display six sub-field images. The display sequence control section 12 performs control to display, in successive time sequence, two green field images G1 corresponding to two fields into a mid-timing zone within a frame period. The display sequence control section 12 also controls the display sequence of field images of respective colors to display a red field image R1 and a blue field image B1 in this order backward from the mid-timing zone for the green field images G1 as well as the red field image R1 and the blue field image B2 in this order forward from the mid-timing zone for the green field images G1. In other words, the display sequence control section 12 controls the display sequence to display field images in a sequence of colors B, R, G, G, R and B.

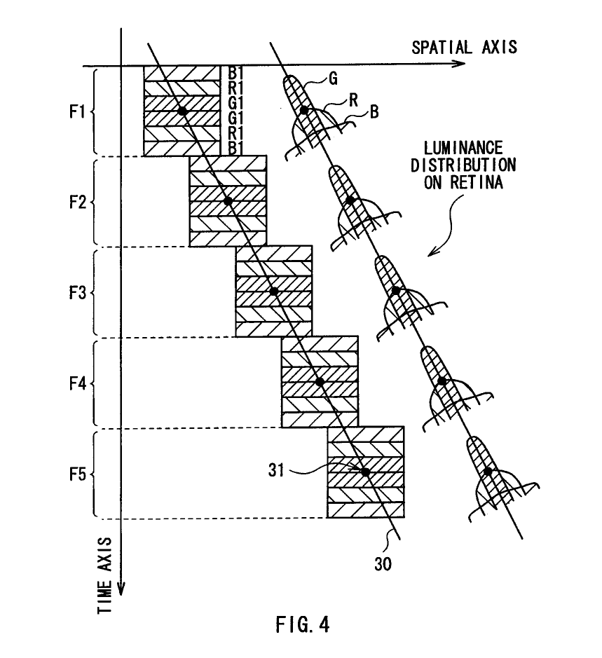

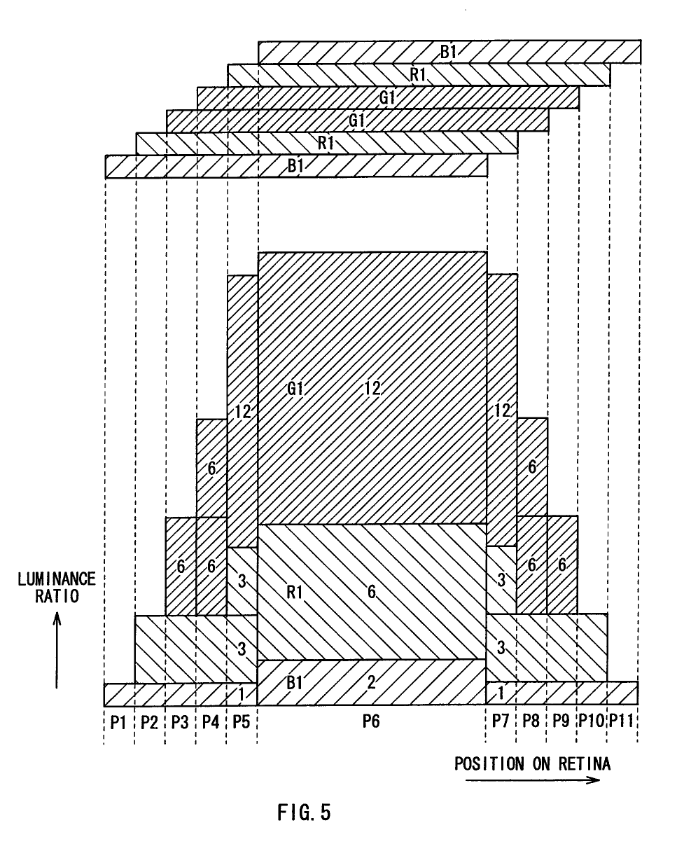

FIG. 4 schematically illustrates a display state of a picture with motion in the embodiment. FIG. 4 illustrates a state where a frame image configured of field images illustrated in FIGS. 2 and 3 moves to the right. FN indicates an Nth (where N=1, 2, 3, . . . ) frame in time sequence. A vertical axis indicates a time axis (sec) and a horizontal axis indicates a spatial axis. The unit of the spatial axis is, for example, an arbitrary unit such as deg, mm or pix (pixel unit). In FIG. 4, images superimposed on a retina (a luminance distribution on a retina) in respective frames during eye tracking are also illustrated simply. The eye-tracking line 30 is represented by a line connecting luminance barycenters 31 of respective frames. Herein, the luminance barycenter 31 is located in a central position of the green field image G1 displayed at the center of a frame period.

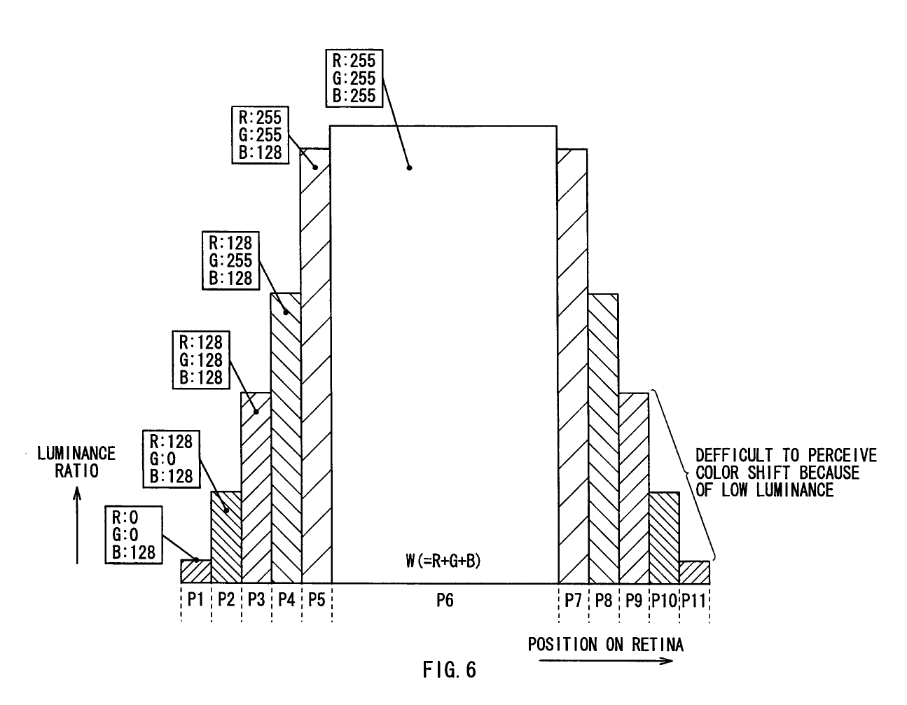

FIG. 5 schematically illustrates a luminance distribution of each color component on a retina within a frame period in the display state illustrated in FIG. 4. Moreover, FIG. 6 schematically illustrates a composite luminance distribution of respective colors on a retina. P1 to P11 indicate regions on a retina. In FIG. 5, the luminance ratio of respective colors in each region is numerically represented. In FIG. 6, the ratio of respective colors in each region is represented by a signal level value.

It is clear from FIGS. 5 and 6 that in the embodiment, a composite luminance distribution which is perceived by a viewer on his retina and is created based on a group of field images configuring one frame in the picture in motion displayed has highest luminance in a mid-range thereof (the region P6 in FIGS. 5 and 6). Moreover, the composite luminance distribution has luminance getting lower toward a periphery thereof to spread with bilateral-symmetry.

In an example in FIGS. 5 and 6, an example in which white is displayed is illustrated; therefore, in a periphery on a retina (around the regions P1 and P2 or the regions P10 and P11), a color shift occurs mainly due to a red component and a blue component. However, when the human visual characteristics are considered, in the display method in the embodiment, the color shift in the periphery is hardly perceived. In the human visual characteristics, the brightness of luminance is perceivable in a sequence of green, red and blue. Moreover, human eyes have frequency resolution (spatial resolution) for green, red and blue in a decreasing sequence. In other words, the human eyes have characteristics that a color shift in green is easily perceived and a color shift in blue is less likely to be perceived. By such visual characteristics, the embodiment is allowed to suppress color breakup occurring during eye tracking of a picture with motion.

[Relationship Between Human Visual Characteristics and Perception of Color Shift]

Next, the human visual characteristics will be described in more detail below. A relationship with perception of a color shift will be also described below.

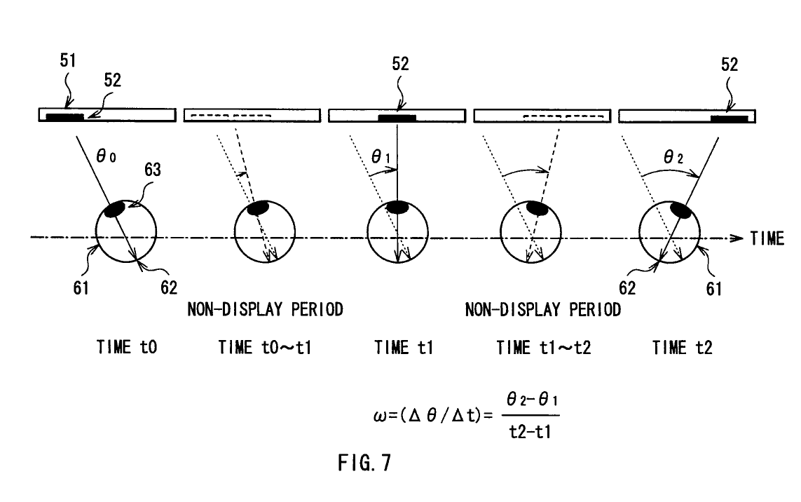

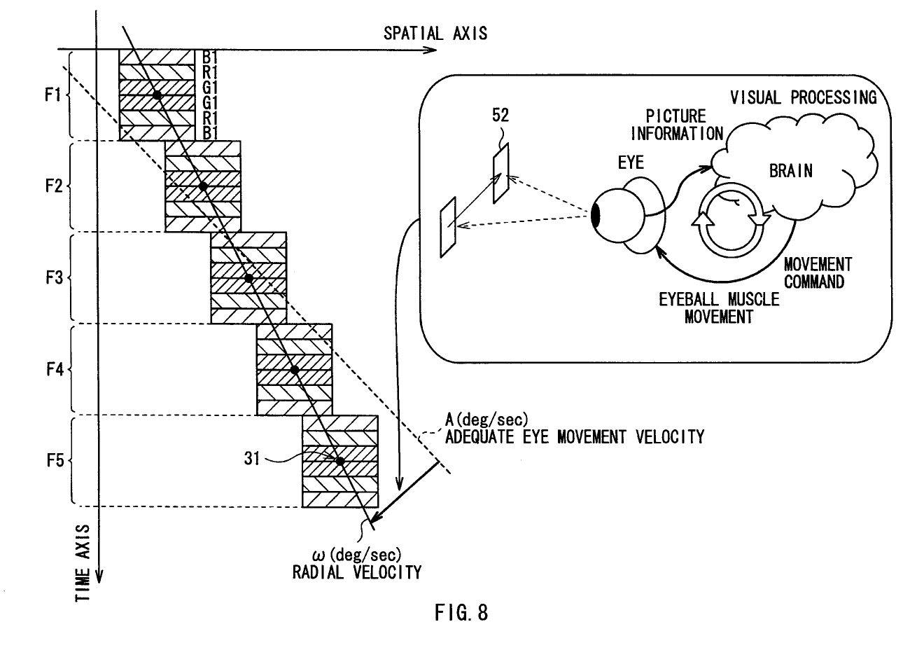

FIG. 7 schematically illustrates movement of an eyeball 61 in the case where the eyeball 61 tracks a moving object 52 displayed on the display 51. FIG. 8 illustrates an eye-tracking line (eye-tracking velocity line) in the case where a moving object is tracked. In FIG. 7, the moving object 52 is intermittently displayed on the display 51 at times t0, t1 and t2 with non-display periods from t0 to t1 and from t1 to t2 in between. Light from the displayed moving object 52 forms an image on a retina 62 through a crystalline lens 63 of the eyeball 61. It is known that in the case where images are successively, time-divisionally displayed and are pictures in motion, to allow an image viewer to see a displayed picture with motion, the eyeball 61 tracks the moving object at a constant angular velocity ω close to the movement velocity of the moving object. Radial velocity is often represented by angular velocity (deg/sec).

ω=(Δθ/Δt)

In the case of display as illustrated in FIG. 7, while an image is not displayed (a non-display period), the eyeball 61 continuously predictively moves at a velocity corresponding to time and space where a next image appears to be displayed. Assuming that an average eye-tracking velocity is A (deg/sec). A precise mechanism of functions of optic nerves of a human brain for determining the velocity A to be equal to the constant angular velocity is not fully revealed; however, the mechanism is allowed to be presumed from data or experimental facts obtained by various experiments by predecessors. It is known that in perception time by color, in the case where luminance is high or equal, perceptual velocity varies in a rough color sequence of R>G>B.

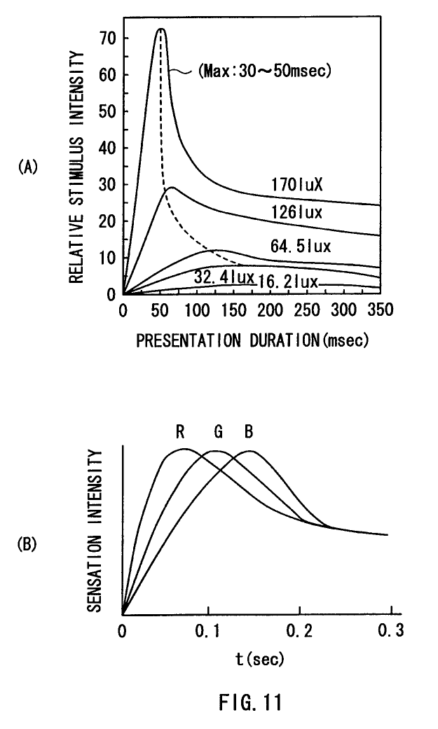

FIG. 11(A) illustrates a relationship between light stimulus presentation duration and apparent brightness. FIG. 11(B) illustrates sensuous intensity changes in apparent brightness of respective colors. As illustrated in FIG. 11(A), there is a visual characteristic that as light is higher in luminance, and shorter in presentation duration, the light is perceived brighter. As illustrated in FIG. 11(B), apparent brightness is maximized in a time sequence of colors. Thus, time sensitivity is high in a decreasing sequence of red and green; however, the visibility of luminance in red and green is 3 and 6, respectively, and a difference therebetween is twice. Therefore, it is presumed that during eye-tracking of field-sequential images of three colors RGB, sensitivity for green is generally higher, and significantly contributes to the configuration of a movement velocity line (eye-tracking line).

More precisely, the average eye-tracking velocity A is determined not only by the visual characteristics but also by action of the optic nerve center in a human brain. As illustrated in FIG. 8, the brain performs visual processing on picture information from an eye. With the movement of an image, an eyeball tracks the image while muscular movement of the eyeball is limited by the brain. when a plurality of field images decomposed by colors reach an eye in a time-divisional sequence to be combined on a retina, the brain determines to allow “a more easily viewable image”≈“a clear image with high luminance” to be approximately at a viewing center. Then, it is considered that the brain performs approximate servo control on the eye-tracking velocity at velocity where a favorable image is obtainable. Therefore, a portion corresponding to a luminance barycenter in a composite luminance distribution on a retina is considered as the viewing center to be tracked by the eye.

When the case where a plurality of field images decomposed by RGB time-sequentially reach the eye to be combined is considered, a color with a high luminance level is generally green in color images. Therefore, the green field image G is considered as the luminance barycenter in a combination of the field images, and an average velocity line focused on the movement velocity of the green field image G is GV. An eye-tracking line in a combination of other colors does not always correspond to GV, and as a result of an image where colors are superimposed, the eye-tracking line is located in a portion with high luminance as a whole. When the image is tracked in such a manner, a burden on a sense of sight is reduced naturally, and after that, the brain controls eyeball movement to track the portion. The velocity ω of viewpoint movement by the eyeball at this time is represented by a solid line as the eye-tracking line 30 in a space-time diagram (FIG. 4) of the embodiment. A gradient of the eye-tracking line 30 indicates the velocity ω.

In the display method in the embodiment, when the luminance barycenter 31 of a composite image configured of the field images is tracked approximately at the movement velocity ω, field images of respective colors are configured in a display sequence where a spatial shift in the composite image is minimized. Therefore, color breakup perceived in a RGB display system in related art illustrated in FIGS. 29 and 30 is allowed to be reduced.

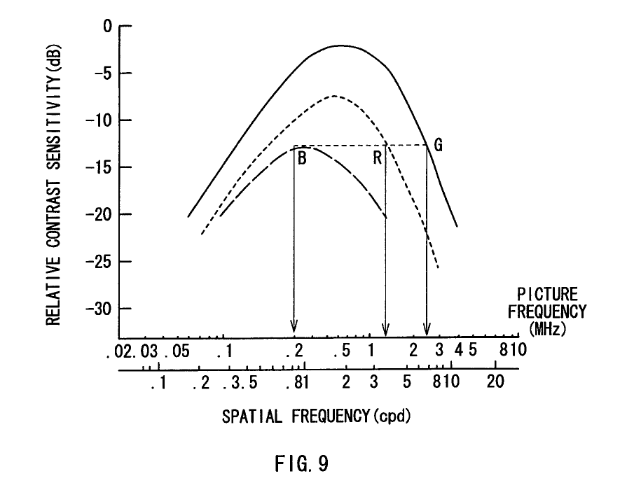

FIG. 9 illustrates spatial frequency characteristics of human eyes with respect to chromaticity. FIG. 9 illustrates the characteristics in the case of a sine wave pattern when a still picture is viewed, and the characteristics are not perfectly equivalent to Landolt ring vision; however, the characteristics indicate that green, red and blue are mutually different in relative contrast sensitivity by approximately 6 dB (twice) at a picture frequency of 500 KHz or over in a sequence of green>red>blue. Moreover, there is implication that in the case where red and blue have equal peaks at which equal contrast is perceived, equal luminance is obtained at approximately 200 KHz in blue, 1.3 MHz in red and 2.6 MHz in green. Such knowledge is used in a band compression technique of a color signal in an NTSC television or the like. When frequency resolution is replaced with dimension, it is considered that even if blue has a displacement or a spatial spread 7 times larger than red, the displacement or the spatial spread is not easily perceived stimulatingly. Moreover, the frequency resolution of red is close to a half of the frequency resolution of green. Therefore, it is considered that even if blue has a displacement or a spatial spread approximately 14 times larger than green, the displacement or the spatial spread is not easily perceived stimulatingly. Therefore, relative acceptable amounts of the displacement or the spatial spread in red and blue establish relationships of R<2 and B<14, where G=1.

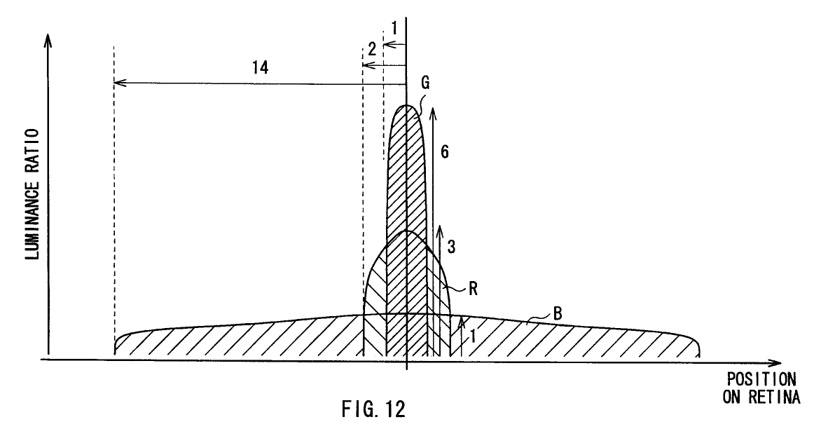

FIG. 12 schematically illustrates the acceptable amount of a spatial color shift based on such human visual characteristics.

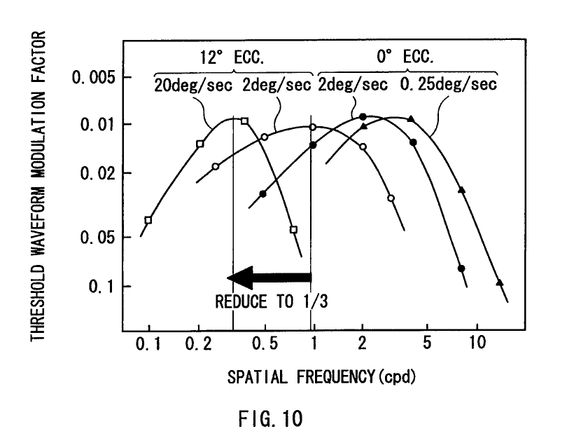

FIG. 10 illustrates spatial frequency characteristics of human eyes with respect to the movement velocity of a displayed object. In FIG. 10, characteristics in the case where the object is viewed from a central retinal fovea (0° ECC) at movement velocities of 2 deg/sec and 0.25 deg/sec and characteristics in the case where the object is viewed from a peripheral position at 12° (12° ECC) from the central retinal fovea at movement velocities of 20 deg/sec and 2 deg/sec. As illustrated in FIG. 10, a decline in vision luminance-stimulatingly occurs under a moving picture display state. The journal of the Institute of Television Engineers of Japan Vol. 40, No. 1 (1986), P. 46-53 or the journal of the Institute of Television Engineers of Japan Vol. 40, No. 4 (1986), P. 266-273 discloses that visual angular velocity capable of following the movement velocity is approximately 0≦ω≦24 deg/s. On the other hand, as illustrated in FIG. 10, there is a characteristic in which resolving power is reduced to ⅓ or less at a tracking velocity of 20 deg/sec. Therefore, the acceptable amount limit, in a still picture, of deviation of each color in a composite image on a retina in a display time position from an eye-tracking line depends on movement velocity. In the display method in the embodiment, the eye-tracking line 30 is determined depending on a luminance distribution on a retina determined as a result of a time-space diagram (FIG. 4), and the spatial spread of an image is increased or reduced depending on movement velocity. It is considered that when the range of the spread is limited in a still picture state, in a moving picture, resolving power is further deteriorated to reduce perception of deviation to ⅓. FIG. 12 illustrates frequency resolution considered as the acceptable amount of deviation. It is considered that even if blue has a spatial spread of deviation which is 7 times larger than that of red (14 times larger than that of green), deviation in blue is not easily perceivable. In FIG. 9, the spatial resolution of red is equal to half or smaller of that of green when viewing a still picture; therefore, FIG. 12 illustrates that red has an acceptable spatial spread twice higher than that of green. In reality, in an image with high luminance, there is a tendency to reduce the acceptable amount of deviation, and an image with low luminance tends to have eased conditions. In summary, the acceptable amount of deviation has a ratio slightly larger than an inverse of a luminance ratio, and a perceptual ability is reduced with movement velocity; therefore, conditions are further eased.

As illustrated in FIG. 4, the following is established when the eye-tracking line 30 is located on the luminance barycenter 31 of a composite image configured of field images. An inter-frame image movement amount depends on movement velocity.

Deviation(spread)amount=inter-frame image movement amount/number of fields in a frame (1)

Conditions allowing a color shift not to be perceived are as follows in summary. In the embodiment, the configuration and display sequence of field images are controlled to satisfy the following conditions. Moreover, in second to sixth embodiments which will be described later, control is performed to satisfy the following conditions.

1. As illustrated in FIG. 12, deviation satisfies a band spatial contrast vision characteristic ratio (FIG. 9) of R<2 and B<14, where G=1.
2. The equation (1) is equal to or smaller than the amount of band attenuation varying depending on movement velocity in a moving picture.
3. The spread of a luminance distribution is bilaterally symmetric with respect to an eye-tracking line.

### Second Embodiment

Next, an image display apparatus according to a second embodiment of the invention will be described below. It is to be noted that like components are denoted by like numerals as of the image display apparatus according to the above-described first embodiment and will not be further described.

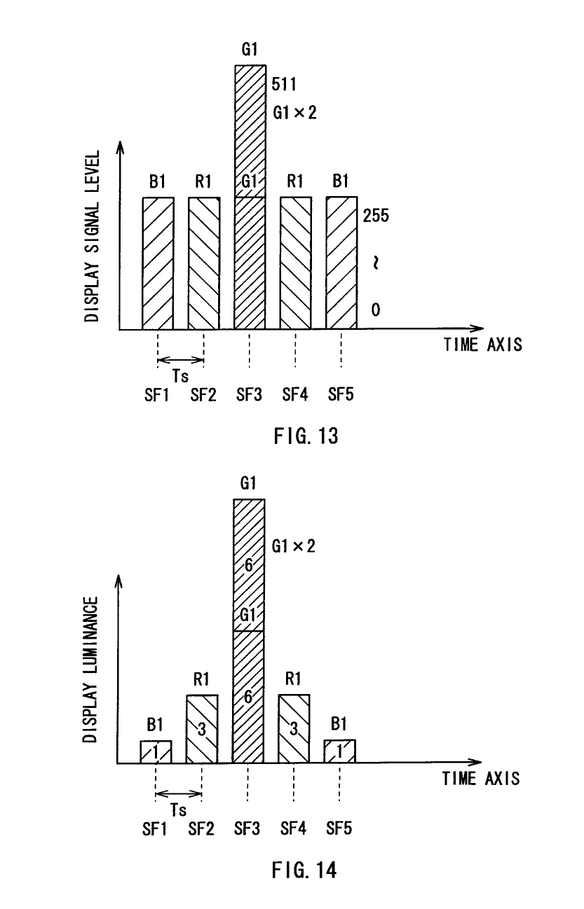

FIG. 13 illustrates structures of sub-field images within a frame period displayed in the embodiment, where a vertical axis indicates a display signal level. In FIG. 13, as in the case of FIG. 2, the signal level of a black level is 0, and the signal level of a white level is 255, and a white image (a white-level image) is displayed. FIG. 14 is an explanatory diagram illustrating structures of the sub-field images in FIG. 13, where a vertical axis is a display luminance level. In FIG. 14, as in the case of FIG. 3, the luminance ratio of RGB primary-color signals is typically represented as R:G:B of 3:6:1.

As illustrated in FIGS. 13 and 14, in the embodiment, one frame is divided into five sub-fields SF1 to SF5 to display five sub-field images. In the embodiment, the image processing section 11 (FIG. 1) generates, as a green field image, an image with a doubled signal level which is twice as high as that of a green component in an input image. The display sequence control section 12 performs control to display the green field image G1 with the doubled signal level into a mid-timing zone within a frame period. The display sequence control section 12 also controls the display sequence of field images of respective colors to display a red field image R1 and a blue field image B1 in this order backward from the mid-timing zone for the green field image as well as the red field image R1 and the blue field image B1 in this order forward from the mid-timing zone for the green field image. In other words, the display sequence control section 12 controls the display sequence to display field images in a sequence of colors B, R, G (doubled luminance), R and B. It is to be noted that in the embodiment, more specifically, to display the green field image with doubled luminance, the light emission amount of the backlight 3 is controlled.

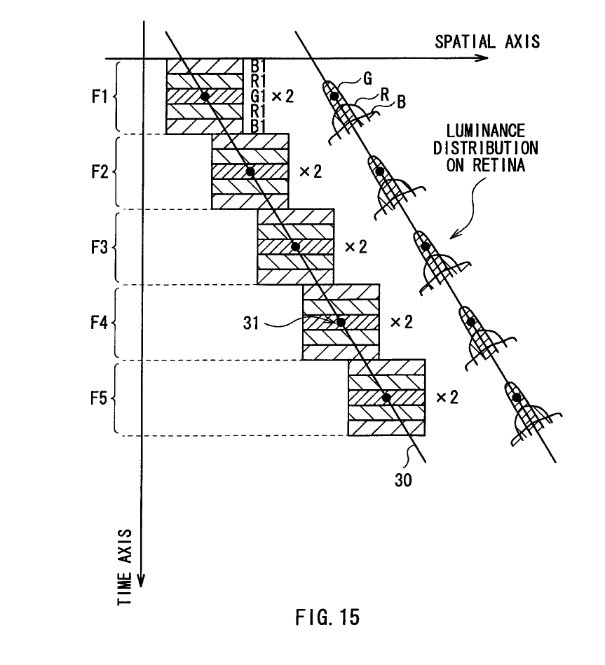

FIG. 15 schematically illustrates a display state of a picture with motion in the embodiment as in the time-space diagram in FIG. 4. In FIG. 15, images superimposed on a retina (a luminance distribution on a retina) in respective frames during eye tracking are also illustrated simply. The eye-tracking line 30 is represented by a line connecting luminance barycenters 31 of respective frames. In the embodiment, the luminance barycenter 31 is also located at a central position of the green field image G1 displayed at the center of a frame period.

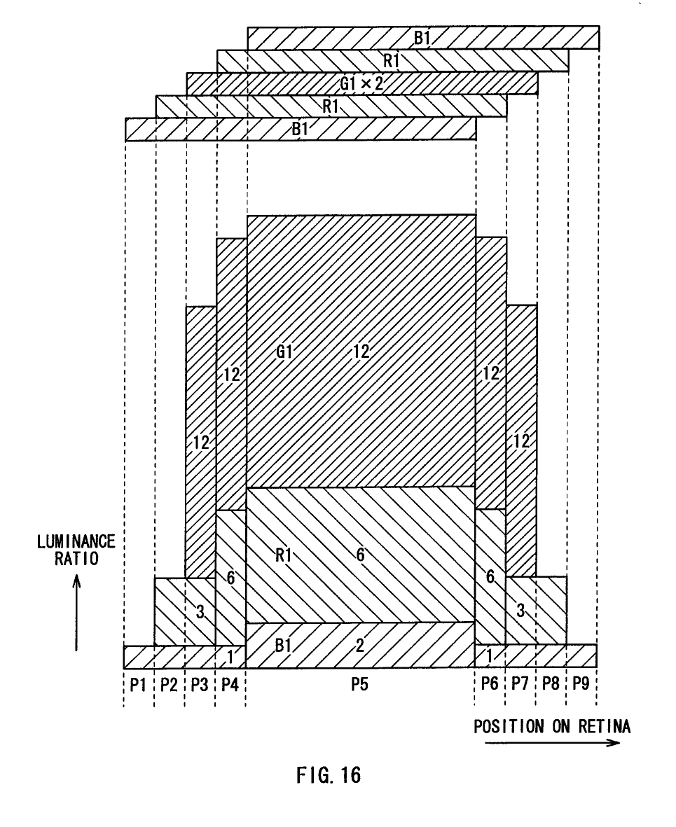

FIG. 16 schematically illustrates, as in the case of FIG. 5, a luminance distribution of each color component on a retina within a frame period in the display state illustrated in FIG. 15. It is clear from FIG. 16 that also in the embodiment, a composite luminance distribution which is perceived by a viewer on his retina and is created based on a group of field images configuring one frame in the picture with motion has highest luminance in a mid-range thereof (a region P5 in FIG. 16). Moreover, the composite luminance distribution has luminance getting lower toward a periphery thereof to spread with bilateral-symmetry. Therefore, also in the embodiment, when the human visual characteristics are considered, a color shift in the periphery is hardly perceived, and color breakup occurring during eye tracking of a picture with motion is allowed to be suppressed.

### Third Embodiment

Next, an image display apparatus according to a third embodiment of the invention will be described below. It is to be noted that like components are denoted by like numerals as of the image display apparatus according to the above-described first or second embodiment and will not be further described.

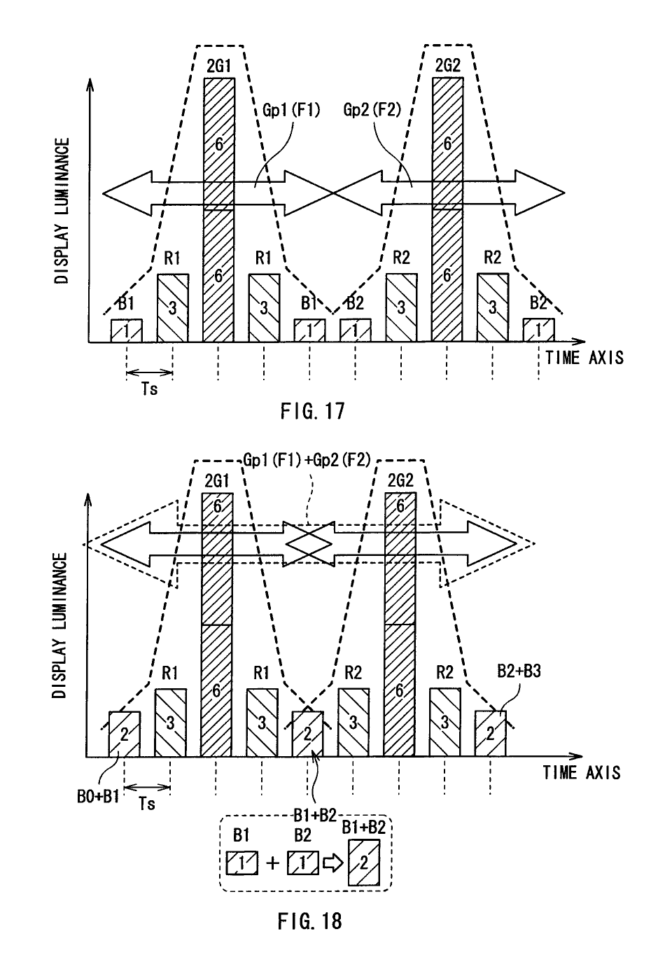

FIG. 17 illustrates a display state within two frame periods displayed in the above-described second embodiment, where a vertical axis indicates a display luminance level. FIG. 18 illustrates a display state within two frame periods displayed in the embodiment, where a vertical axis indicates a display luminance level. Gp1 indicates an entire combination of field images in a first frame F1 and Gp2 indicates an entire combination of field images in a second frame F2. In the embodiment, compared to the display method in FIG. 17, most peripheral field images (blue field images) in time sequence in two adjacent frames are combined into one field image to be displayed.

In the embodiment, the image processing section 11 (FIG. 1) generates, as a green field image, an image with a doubled signal level which is twice as high as that of a green component in an input image. Moreover, a first composite blue field image which is a composition (B0+B1) of a blue field image in a preceding frame F0 and a blue field image in a present frame F1 is generated. Further, a second composite blue field image which is a composition (B1+B2) of the blue field image in the present frame F1 and a blue field image in a following frame F2 is generated.

The display sequence control section 12 performs display control to display the first composite blue field image into an overlapping timing zone in which the preceding frame F0 and the present frame F1 overlap each other. Moreover, display control is performed to display the second composite blue field image into an overlapping timing zone in which the present frame and the following frame overlap each other. The display sequence control section 12 displays the green field image G1 with the doubled signal level into a mid-timing zone between the first composite blue field image and the second composite blue field image. Moreover, the display sequence of field images of respective colors is controlled to display the red field image R1 between the first composite blue field image and the green field image G1 and display the red field image R1 between the green field image G1 and the second composite blue field image.

In such a display method, when field images from the first composite blue field image (B0+B1) to the second composite blue field image (B1+B2) are considered as a group of field images which configures one frame, a composite luminance distribution, on a retina, which is created based on the group of field images has highest luminance in a mid-range thereof. Moreover, the composite luminance distribution has luminance getting lower toward a periphery thereof to spread with bilateral-symmetry. Therefore, also in the embodiment, when the human visual characteristics are considered, a color shift in the periphery is hardly perceived, and color breakup occurring during eye tracking of a picture with motion is allowed to be suppressed.

### Fourth Embodiment

Next, an image display apparatus according to a fourth embodiment of the invention will be described below. It is to be noted that like components are denoted by like numerals as of the image display apparatuses according to the above-described first to third embodiments and will not be further described.

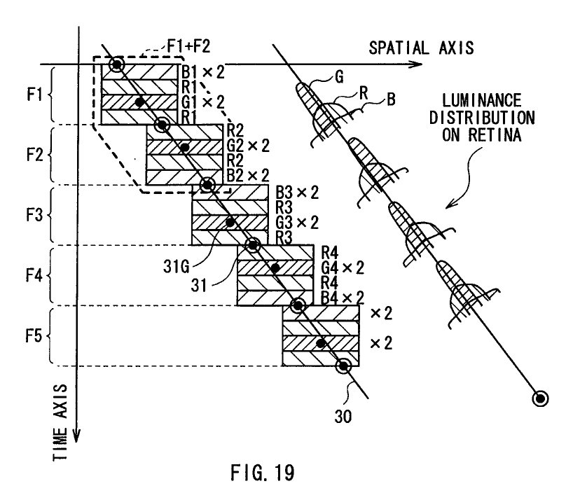

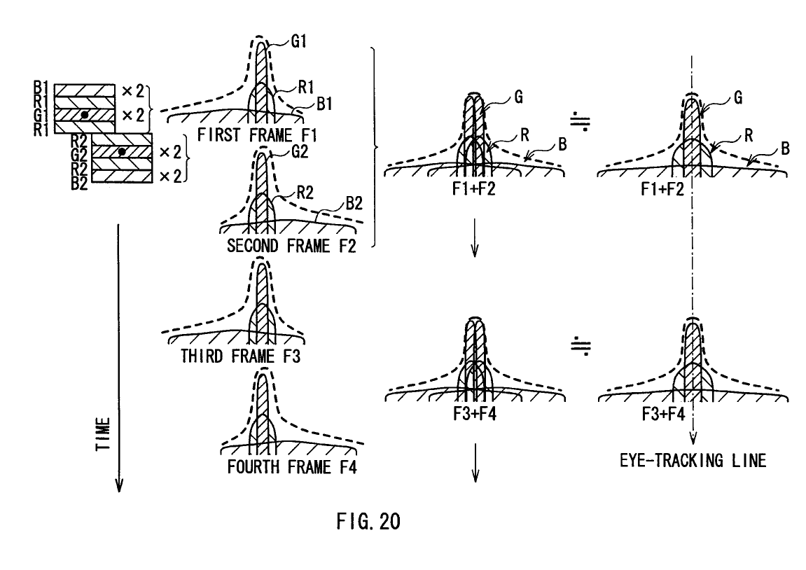

FIG. 19 schematically illustrates a display state of a picture with motion in the embodiment as in the time-space diagram in FIG. 4. FIG. 19 simply illustrates images superimposed on a retina (a luminance distribution on a retina) in respective frames during eye tracking, and FIG. 20 schematically illustrates a composite luminance distribution on a retina within two frame periods in the display state illustrated in FIG. 19.

In the above-described first to third embodiments, when the picture with motion is displayed, the display sequence of field images of plural colors is controlled to allow a composite luminance distribution which is perceived by a viewer on his retina and is created based on a group of field images configuring one frame to have a predetermined profile. On the other hand, in the embodiment, the display sequence control section 12 controls the display sequence of field images of plural colors to allow a composite luminance distribution which is perceived by a viewer on his retina and is created based on a group of field images configuring not one frame but two frames in successive time sequence to have a predetermined profile.

The display sequence control section 12 controls the display sequences of field images of plural colors in the first frame F1 to be different from that in the second frame F2 which follows the first frame in successive time sequence. Then, as illustrated in FIG. 20, a composite luminance distribution which is perceived by a viewer on his retina and is created based on a group of field images configuring two frames has highest luminance in a mid-range thereof, and has luminance getting lower toward a periphery thereof. Accordingly, the display sequence of field images of plural colors is controlled to allow the composite luminance distribution to spread with bilateral-symmetry.

In the embodiment, the image processing section 11 (FIG. 1) generates, as a green field image and a blue field image, images with doubled signal levels twice as high as the signal levels of a green component and a blue component in an input image, respectively. The display sequence control section 12 controls the display sequence of field images of respective colors to display a blue field image B1 with the doubled signal level, a red field image R1, a green field image G1 with the doubled signal level, and the red field image R1 in this order within a display period of a first frame. The display sequence of field images of respective colors is controlled to display a red field image R2, a green field image G2 with the doubled signal level, the red field image R2 and a blue field image B2 with the doubled signal level in this order within a display period of a second frame. Thus, in the embodiment, the display sequence of field images of respective colors within the second frame F2 is an inverse of the display sequence within the first frame F1.

In FIG. 19, the eye-tracking line 30 is represented by a line connecting luminance barycenters 31 in a state where two frames are combined. In the embodiment, the luminance barycenter 31 does not correspond to a central position 31G of the green field image. Even in such a display method, a composite luminance distribution which is perceived by a viewer on his retina and is created based on a group of field images configuring two frames has highest luminance in a mid-range thereof. Moreover, the composite luminance distribution has luminance getting lower toward a periphery thereof to spread with bilateral-symmetry. Therefore, also in the embodiment, when the human visual characteristics are considered, a color shift in the periphery is hardly perceived, and color breakup occurring during eye tracking of a picture with motion is allowed to be suppressed.

### Fifth Embodiment

Next, an image display apparatus according to a fifth embodiment of the invention will be described below. It is to be noted that like components are denoted by like numerals as of the image display apparatuses according to the above-described first to fourth embodiments and will not be further described.

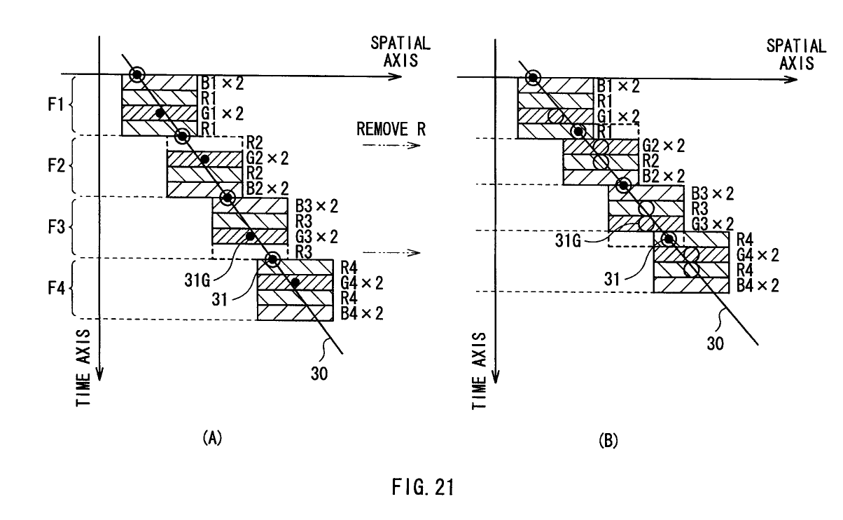

FIG. 21(B) schematically illustrates a display state of a picture with motion in the embodiment as in the time-space diagram in FIG. 4. FIG. 21(A) illustrates a state where some of the red components in the display state in FIG. 19 are removed. In the embodiment, as illustrated in FIG. 21(B), the display sequence control section 12 performs display control to remove some of the red components in the display state illustrated in FIG. 19 and further close up display spaces formed by removing the red components, thereby performing display.

Even in such a display method, a composite luminance distribution which is perceived by a viewer on his retina and is created based on a group of field images configuring two frames has highest luminance in a mid-range thereof. Moreover, the composite luminance distribution has luminance getting lower toward a periphery thereof to spread with bilateral-symmetry. Therefore, also in the embodiment, when the human visual characteristics are considered, a color shift in the periphery is hardly perceived, and color breakup occurring during eye tracking of a picture with motion is allowed to be suppressed.

### Sixth Embodiment

Next, an image display apparatus according to a sixth embodiment of the invention will be described below. It is to be noted that like components are denoted by like numerals as of the image display apparatuses according to the above-described first to fifth embodiments and will not be further described.

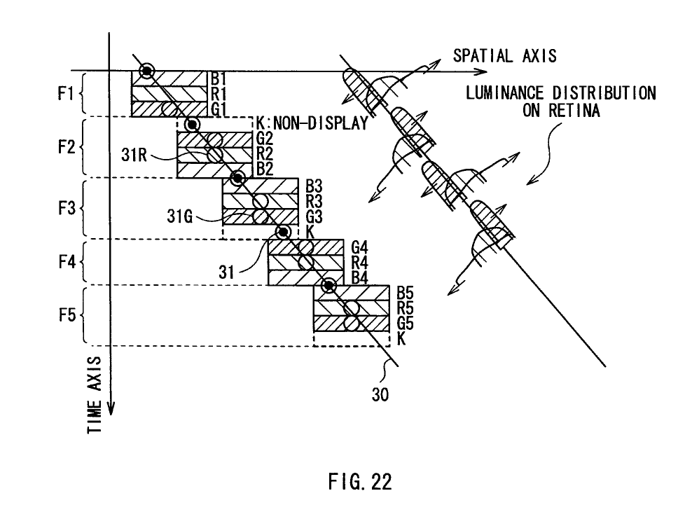

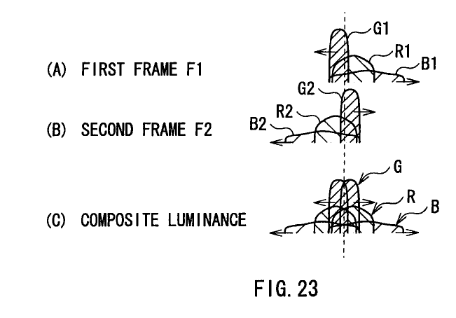

FIG. 22 schematically illustrates a display state of a picture with motion in the embodiment as in the time-space diagram in FIG. 4. While FIG. 22 simply illustrates images superimposed on a retina (a luminance distribution on a retina) in respective frames during eye tracking, FIG. 23(C) schematically illustrates a composite luminance distribution on a retina within two frame periods in the display state illustrated in FIG. 22. FIG. 23(A) schematically illustrates a luminance distribution of field images in the first frame F1 on a retina in the display state illustrated in FIG. 22. FIG. 23(B) schematically illustrates a luminance distribution of field images in the second frame F2 on a retina in the display state illustrated in FIG. 22. FIG. 23(C) schematically illustrates a state where the luminance distributions illustrated in FIGS. 23(A) and 23(B) are combined.

In the embodiment, the display sequence control section 12 controls the display sequence of field images of plural colors to allow a composite luminance distribution which is perceived by a viewer on his retina and is created based on a group of field images configuring two frames in successive time sequence to have a predetermined profile. The display sequence control section 12 controls the display sequences of field images of plural colors in the first frame F1 and the second frame F2, which are arranged in successive time sequence, to be different from each other. Then, as illustrated in FIG. 23(C), the composite luminance distribution which is perceived by a viewer on his retina and is created based on a group of field images configuring two frames has highest luminance in a mid-range thereof, and has luminance getting lower toward a periphery thereof. Accordingly, the display sequence of the field images of plural colors is controlled to allow the composite luminance distribution to spread with bilateral-symmetry.

In the embodiment, the image processing section 11 (FIG. 1) generates, as field images of plural colors, field images of three colors, i.e., red field images, green field images and blue field images. The display sequence control section 12 controls the display sequence of field images of respective colors to display the blue field image B1, the red field image R1 and the green field image G1 in this order within a display period of the first frame F1. The display sequence of field images of respective colors is controlled to display the green field image G2, the red field image R2 and the blue field image B2 in this order within a display period of the second frame. Thus, in the embodiment, the display sequence of field images of respective colors within the second frame F2 is an inverse of the display sequence within the first frame F1. Moreover, in the embodiment, the display sequence control section 12 performs display control to allow a non-display section K having a time length corresponding to that of one field period to be inserted between the display period of the first frame F1 and the display period of the second frame F2. It is to be noted that in FIG. 22, an example in which the non-display section K is disposed at the top of the second frame F2 is illustrated; however, instead of this, an example in which the non-display section K is disposed at the end of the first frame F1 is substantially the same.

In FIG. 22, the eye-tracking line 30 is represented by a line connecting the luminance barycenters 31 in a state where two frames are combined. In the embodiment, the luminance barycenter 31 does not correspond to the central position 31G of the green field image or a central position 31R of the red field image. Even in such a display method, a composite luminance distribution which is perceived by a viewer on his retina and is created based on a group of field images configuring two frames has highest luminance in a mid-range thereof. Moreover, the composite luminance distribution has luminance getting lower toward a periphery thereof to spread with bilateral-symmetry. Therefore, also in the embodiment, when the human visual characteristics are considered, a color shift in the periphery is hardly perceived, and color breakup occurring during eye tracking of a picture with motion is allowed to be suppressed.

### Comparative Example Relative to Sixth Embodiment

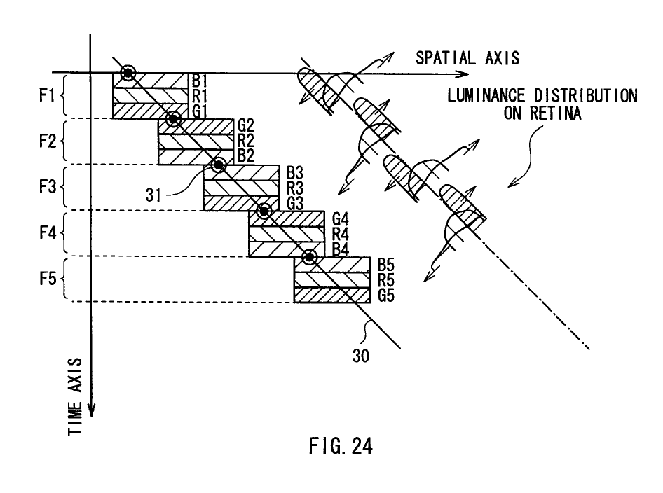

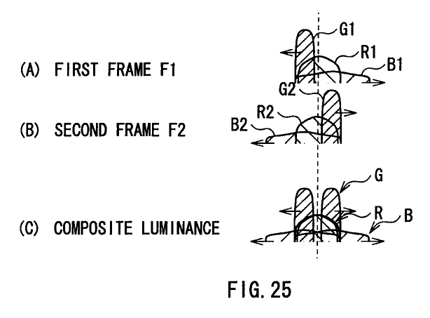

FIG. 24 schematically illustrates a display state of an image in a comparative example relative to the sixth embodiment (FIG. 22). While FIG. 24 simply illustrates images superimposed on a retina (a luminance distribution on a retina) in respective frames during eye tracking, FIG. 25(C) schematically illustrates a composite luminance distribution on a retina within two frame periods in the display state in FIG. 24. FIG. 25(A) schematically illustrates a luminance distribution of field images in the first frame F1 on a retina in the display state in FIG. 24. FIG. 25(B) schematically illustrates a luminance distribution of field images in the second frame F2 on a retina in the display state illustrated in FIG. 24. FIG. 25(C) schematically illustrates a state where the luminance distributions illustrated in FIGS. 25(A) and 25(B) are combined.

In a display method in the comparative example illustrated in FIG. 24, the display sequences of field images of respective colors in respective frames are the same as those in the display method in FIG. 22. However, the non-display section K is not disposed between adjacent frames. In such a display method, as illustrated in FIG. 25(C), a composite luminance distribution which is perceived by a viewer on his retina and is created based on a group of field images configuring two frames has a profile different from the predetermined profile not allowing a color shift to be perceived. In other words, a part with highest luminance of the luminance distribution (FIG. 25(A)) on the retina in the first frame F1 and a part with highest luminance of the luminance distribution (FIG. 25(B)) on the retina in the second frame F2 are not sufficiently combined in a mid-range of the composite luminance distribution, and are separated from each other on the retina. Therefore, a double image is spatially perceived.

### Seventh Embodiment

Next, an image display apparatus according to a seventh embodiment will be described below. It is to be noted that like components are denoted by like numerals as of the image display apparatuses according to the above-described first to sixth embodiments and will not be further described.

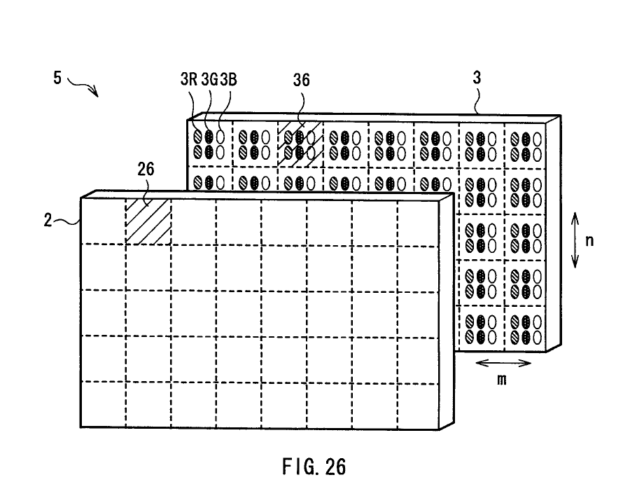

The display methods described in the above-described first to sixth embodiments are applicable to a display performing so-called divisional drive system backlight control. FIG. 26 illustrates a configuration example of a display performing such backlight control.

In FIG. 26, the backlight 3 includes a plurality of light emission sub-regions 36 which are controllable separately from one another and are allowed to individually emit plural kinds of color light. In other words, the backlight 3 is configured of a divisional drive system backlight. More specifically, the backlight 3 includes a plurality of light emission sub-regions 36 by two-dimensionally arranging a plurality of light sources. Therefore, the light source section 3 is divided into n (vertical)×m (horizontal)=K light emission regions (where n and m each are an integer of 2 or over) an in-plane direction. It is to be noted that the number of the light emission regions is lower than the resolution of display pixels. Moreover, a plurality of divisional irradiated regions 26 corresponding to the light emission sub-regions 36, respectively, are formed in the display panel 2. The display panel 2 modulates color light emitted from each of the light emission sub-regions 36 based on an image signal.

The backlight 33 is allowed to independently perform light emission control of the light emission sub-regions 36 based on an input picture signal. In this case, a light source is configured of a combination of LEDs of respective colors, i.e., a red LED 3R emitting red light, a green LED 3G emitting green light and a blue LED 3B emitting blue light, and respective kinds of color light are additively mixed to emit plural kinds of color light. One or more light sources with such a configuration are disposed in each of the light emission sub-regions 36.

### Other Embodiments

The present invention is not limited to the above-described respective embodiments, and may be variously modified.

The case where field images of three primary colors, i.e., red, green and blue are generated as field images of plural colors to be time-divisionally displayed is described as an example in the above respective embodiments; however, color display may be performed with use of colors other than the three primary colors. For example, color display may be performed with use of, for example, other three colors having slightly different color phases from those of pure three primary colors.

Moreover, as field images of plural colors, field images of complementary three colors such as yellow (Ye), cyan (Cy) and magenta (Mg) may be generated to be time-divisionally displayed. Ye is a composite color of R and G, Cy is a composite color of G and B, and MG is a composite color of R and B. The decreasing luminance sequence of visibility in human eyes is Ye(=R+G)>Cy(=G+B)>Mg(=R+B). The decreasing sequence of frequency resolution by human eyes and the decreasing sequence of the width of band sensitivity are also Ye>Cy>Mg. Therefore, in time-dimensional display by field images of these complementary three colors, relative acceptable amounts of a displacement or a spatial spread in Ye and Mg are smallest and largest, respectively, and it is considered that a color shift is easily perceived in a sequence of Ye>Cy>Mg. Therefore, when respective colors, R, G and B in the above-described respective embodiments are replaced with Cy, Ye and Mg, respectively, to perform display, the same effect of reducing color breakup is obtained. For example, instead of the display sequence of “B, R, G, G, R and B” in the above-described first embodiment, a method of displaying in a sequence of “Mg, Cy, Ye, Ye, Cy and Mg” within a frame period may be used.

1. An image display apparatus comprising:
a signal processing section decomposing, in each frame, an input image into a plurality of color-component images necessary for color display to generate field images of plural colors for a field-sequential display;
a display sequence control section variably controlling, in each frame, a display sequence of the field images of plural colors within a frame period; and
a display section time-divisionally displaying, in a manner of the field-sequential display, the field images of plural colors in the display sequence controlled by the display sequence control section,
wherein the display sequence control section controls the display sequence of the field images of plural colors to allow a composite luminance distribution to have a predetermined profile, the composite luminance distribution being created, in consideration of luminosity factor, based on a group of field images which configures a frame or two frames in successive time sequence in a picture with motion displayed on the display section, the predetermined profile having highest luminance in a mid-range thereof and having luminance getting lower toward a periphery thereof to spread with bilateral-symmetry.

2. The image display apparatus according to claim 1, wherein
the signal processing section decomposes the input image into primary-color images of red, green and blue components as the plurality of color-component images to generates, as the field images of plural colors, field images of three colors, i.e., a red field image, a green field image and a blue field image.

3. The image display apparatus according to claim 2, wherein
the display sequence control section controls the display sequence of field images of respective colors, to display the green field image into a mid-timing zone within a frame period, and to display the red and blue field images in this order backward from the mid-timing zone for the green field image as well as the red and blue field images in this order forward from the mid-timing zone for the green field image.

4. The image display apparatus according to claim 3, wherein
the display sequence control section controls the display sequence of field images of respective colors, to display, in successive time sequence, two green field images into a mid-timing zone within a frame period, and to display the red and blue field images in this order backward from the mid-timing zone for the two green field images as well as the red and blue field images in this order forward from the mid-timing zone for the two green field images.

5. The image display apparatus according to claim 3, wherein
the signal processing section generates the green field image with a doubled signal level which is twice as high as that of a green component in the input image, and
the display sequence control section controls the display sequence of field images of respective colors, to display the green field image with the doubled signal level into a mid-timing zone within a frame period, and to display the red and blue images in this order backward from the mid-timing zone for the green field image as well as the red and blue field images in this order forward from the mid-timing zone for the green field image.

6. The image display apparatus according to claim 2, wherein
the signal processing section generates the green field image with a doubled signal level which is twice as high as that of a green component in the input image, and generates a first composite blue field image and a second composite blue field image, the first composite blue field image being a composition of a blue field image in a preceding frame and a blue field image in a present frame, the second composite blue field image being a composition of the blue field image in the present frame and a blue field image in a following frame,
the display sequence control section controls the display sequence of field images of respective colors, to display the first composite blue field image into an overlapping timing zone in which the preceding frame and the present frame overlap each other, and to display the second composite blue field image into an overlapping timing zone in which the present frame and the following frame overlap each other, and
the display sequence control section controls the display sequence of field images of respective colors, to display the green field image with the doubled signal level into a mid-timing zone between the first and second composite blue field images, and to display the red field image between the first composite blue field image and the green field image and display the red field image between the green field image and the second composite blue field image.

7. The image display apparatus according to claim 1 or 2, wherein
the display sequence control section performs control to allow a display sequence of the field images of plural colors in a first frame to be different from that in a second frame which follows the first frame in successive time sequence, and
the display sequence control section controls the display sequences of the field images of plural colors to allow a composite luminance distribution to have a predetermined profile, the composite luminance distribution being created, in consideration of luminosity factor, based on a group of field images which configures the first and second frames, the predetermined profile having highest luminance in a mid-range thereof and having luminance getting lower toward a periphery thereof to spread with bilateral-symmetry.

8. The image display apparatus according to claim 7, wherein
the signal processing section generates, as the field images of plural colors, field images of three colors, i.e., a red field image, a green field image and blue field image, the green field image and the blue field image both having doubled signal levels which are twice as high as those of a green component and a blue component in the input image, respectively, and
the display sequence control section controls the display sequence of field images of respective colors, to display the blue field image with the doubled signal level, the red field image, the green field image with the doubled signal level, and the red field image in this order in a display period of the first frame, and to display the red field image, the green field image with the doubled signal level, the red field image, and the blue field image with the doubled signal level in order in a display period of the second frame.

9. The image display apparatus according to claim 7, wherein
the signal processing section generates, as the field images of plural colors, field images of three colors, i.e., a red field image, a green field image and a blue field image, and
the display sequence control section controls the display sequence of field images of respective colors, to display the blue field image, the red field image and the green field image in this order in a display period of the first frame, and to display the green field image, the red field image and the blue field image in this order in a display period of the second frame, and to insert a non-display section having a time length corresponding to that of one field period between the display period of the first frame and the display period of the second frame.

10. The image display apparatus according to claim 1 or 2, wherein
the display section includes:
a light source section including a plurality of light emission subsections configured to be controllable separately from one another and to be allowed to individually emit plural kinds of color light; and
a display panel modulating, based on an image signal, color light emitted from each of the light emission subsections of the light source section.

11. An image display method comprising:
a step of decomposing, in each frame, an input image into a plurality of color-component images necessary for color display in a signal processing section to generate field images of plural colors for a field-sequential display;
a step of variably controlling, in each frame, a display sequence of the field images of plural colors within a frame period by a display sequence control section; and
a step of time-divisionally displaying, in a manner of the field-sequential display, the field images of plural colors in the display sequence controlled by the display sequence control section,
wherein the display sequence control section controls the display sequence of the field images of plural colors to allow a composite luminance distribution to have a predetermined profile, the composite luminance distribution being created, in consideration of luminosity factor, based on a group of field images which configures a frame or two frames in successive time sequence in a picture with motion displayed on the display section, the predetermined profile having highest luminance in a mid-range thereof and having luminance getting lower toward a periphery thereof to spread with bilateral-symmetry.
